(19) United States
(12) Patent Application Publication
(10) Pub. No.: US 2026/0324692 A1
(43) Pub. Date: Oct. 22, 2026

(54) METHOD FOR CONTINUOUS FRYING

(71) Applicant: CARGILL, INCORPORATED, Wayzata, MN (US)

(72) Inventors: Diliara IASSONOVA, Maple Grove, MN (US); Xiaolan LUO, Matthews, NC (US)

(73) Assignee: CARGILL, INCORPORATED, Wayzata, MN (US)

(21) Appl. No.: 19/111,399

(22) PCT Filed: Sep. 18, 2023
(86) PCT No.: PCT/US2023/074429

§ 371 Date: Mar. 13, 2025

Related U.S. Application Data
(60) Provisional application No. 63/376,139, filed on Sep. 19, 2022.

(51) Int. Cl. A23L 5/10; A23L 13/50; A23L 19/18

(52) U.S. Cl. CPC A23L 5/11; A23L 13/50; A23L 19/18

(57) ABSTRACT

The present technology provides a continuous frying process for frying food, the process includes: maintaining two or more characteristics of a frying oil at a targeted value, wherein the targeted value of the two or more characteristics includes: an average composite age of the frying oil is from about 2 days to about 12 days; and a measured total polar material (TPM) value of about 10% to less than or equal to about 22%; and frying a food item in the frying oil at a daily food load of about 0.5 or greater.

### CROSS-REFERENCE TO RELATED APPLICATION

This application claims priority to U.S. Provisional Patent Application No. 63/376,139, filed Sep. 19, 2022, which is incorporated herein in its entirety.

### TECHNICAL FIELD

The present technology relates to methods of frying food, and specifically, methods for frying food via continuous frying process.

### BACKGROUND

Generally, deep-frying is a batch process in which frying oil's life ends until its total polar materials (TPM) content reaches 25%, at which the frying oil is recommended for discarding. Deep-fat frying is one of the oldest and popular food preparations. (Choe et al., Inst. Food Tech., 2007, p. R77-86) Frying is a process of immersing food in hot oil with a contact among frying oil, air, and food at a high temperature (typically at about 150° C. to about 200° C. (302° F. to 392° F.)). The simultaneous heat and mass transfer of frying oil, food, and air during deep-fat frying produces the desirable and unique quality of fried foods. Frying oil acts as a heat transfer medium and contributes to the texture and flavor of fried food. Edible oils (i.e., frying oils) used for frying food, such as in deep fat frying applications, undergo a variety of degradation mechanisms. Such degradation mechanisms may adversely impact frying oil quality, and may include oxidative processes, hydrolysis, and polymerization, as illustrative examples. In conventional frying processes in restaurants, food items are fried in batches in a frying oil until the degradation products (i.e., total polar material, free fatty acids, color, polymerized materials, and others) reach certain levels or exceed certain international thresholds and/or fried food flavor and appearance negatively impacted (dark burnt color, bitter off flavor, etc.). Once the level degradation products reach or exceed unacceptable levels, frying oil is emptied completely from a frying vat and replaced with fresh frying oil.

### SUMMARY

In one aspect, the present technology provides a continuous frying process for frying food, the process includes: maintaining two or more characteristics of a frying oil at a targeted value, wherein the targeted value of the two or more characteristics include: an average composite age of the frying oil in a range of about 2 days to about 12 days; and a measured total polar material (TPM) value of about 10% to less than or equal to about 22%; and frying a food item in the frying oil at a daily food load of about 0.5 or greater.

### BRIEF DESCRIPTION OF THE FIGURES

The drawings illustrate generally, by way of example, but not by way of limitation, various aspects of the present invention.

FIG. 1 illustrates a graph showing the total polar material percentage (TPM, %) as a function of time (days) for the exemplary frying oils evaluated in Example 1, in accordance with various aspects of the present invention.

FIG. 2 illustrates a graph showing the Gardner red color value measured as a function of time (days) for the exemplary frying oils evaluated in Example 1, in accordance with various aspects of the present invention.

FIG. 3 illustrates a graph showing the free fatty acid (FFA, wt %) content measured as a function of time (days) for the exemplary frying oils evaluated in Example 1, in accordance with various aspects of the present invention.

FIG. 4 illustrates a graph showing the composite age (days) as a function of time (days) for the exemplary frying oils evaluated in Example 1, in accordance with various aspects of the present invention.

FIG. 5 illustrates a graph showing the TPM (%) as a function of time (days) for soybean oil evaluated in Example 2, in accordance with various aspects of the present invention.

FIG. 6 illustrates a graph showing the composite age (days) as a function of time (days) for the soybean oil evaluated in Example 2, in accordance with various aspects of the present invention.

FIG. 7 illustrates a graph showing the free fatty acid as oleic (FFA, wt %) content measured as a function of time (days) for soybean oil evaluated in Example 2, in accordance with various aspects of the present invention.

FIG. 8 illustrates a graph showing the Gardner red color value measured as a function of time (days) for soybean oil evaluated in Example 2, in accordance with various aspects of the present invention.

FIG. 9 illustrates a graph showing the lightness of chicken nuggets (L color scale) (a) measured in Example 2, in accordance with various aspects of the present invention.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter. One aspect described in conjunction with a particular embodiment is not necessarily limited to that embodiment and can be practiced with any other embodiment(s).

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y. or about Z” has the same meaning as “about X, about Y, or about Z,” unless indicated otherwise.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

Nothing in the cited references teaches or suggests the claimed process. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

In the methods described herein, the acts can be carried out in a specific order as recited herein. Alternatively, in any embodiment disclosed herein, specific acts may be carried out any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, plus or minus within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the following terms have the following meanings unless expressly stated to the contrary.

As used herein, “frying oils” refers to an edible oil used as a heat transfer medium and contributes to the texture and flavor of fried food.

As used herein, the term “edible oil” refers to a fat or oil that is suitable for human or animal consumption. Edible oils are typically compositions including triacylglycerols (“TAG”). (Scrimgeour et al., “Chemistry of Fatty Acids,” Bailey's Industrial Oil and Fat Products, Seventh Edition, 2020) Edible oils may be obtained from plant, animal, microbial sources, or mixtures thereof. The edible oils, as described herein, may be a modified edible oil; for example, the edible oil may be a hydrogenated oil, a chemically or enzymatically interesterified oil, a fractionated oil, or mixtures thereof. Edible oils may include, but is not limited to, edible oils selected from sunflower oil, grape seed oil, sesame oil, peanut oil, nut oil (such as almond oil, cashew oil, walnut oil, hazelnut oil, macadamia oil, or mixtures thereof), corn oil, wheat kernel oil, rapeseed oil, safflower oil, soybean oil, canola oil, cottonseed oil, rice bran oil, olive oil, or mixtures of two or more thereof. The edible oil may be a high oleic edible oil, such as high oleic sunflower oil, high oleic rapeseed oil, high oleic safflower oil, high oleic soybean oil, high oleic canola oil, high oleic cottonseed oil, or mixtures of two or more thereof. Edible oils may also include, but are not limited to, lard, tallow, coconut oil, palm oil, palm olein, palm kernel oil, hydrogenated vegetable oil (such as hydrogenated fractionated palm kernel oil, hydrogenated cottonseed oil, hydrogenated soybean oil, hydrogenated sunflower oil, hydrogenated canola oil, hydrogenated rapeseed oil, and the like or mixtures thereof), or mixtures of two or more thereof. As used herein, “vegetable oils” refers to oils derived from vegetables and/or oil seeds.

A “triacylglyceride” refers to a molecule having a glycerol moiety that is linked to three fatty acid residues via ester bonds. The terms “triacylglycerol,” “triacylglyceride,” “triglyceride,” and “TAG” are used interchangeably herein.

The term “fatty acid” as used herein can refer to a molecule comprising a hydrocarbon chain and a terminal carboxylic acid group. As used herein, the carboxylic acid group of the fatty acid may be modified or esterified, for example as occurs when the fatty acid is incorporated into a glyceride or another molecule (e.g., COOR, where R refers to, for example, a carbon atom). Alternatively, the carboxylic acid group may be in the free fatty acid or salt form (i.e., COO″ or COOH). The ‘tail’ or hydrocarbon chain of a fatty acid may also be referred to as a fatty acid chain, fatty acid sidechain, or fatty chain. The hydrocarbon chain of a fatty acid will typically be a saturated or unsaturated aliphatic group. A fatty acid having N number of carbons, will typically have a fatty acid side chain having N−1 carbons. However, the subject application also relates to modified forms of fatty acids, e.g., epoxidized fatty acids, and thus the term fatty acid may be used in a context in which the fatty acid has been substituted or otherwise modified as described.

A “fatty acid residue” is a fatty acid in its acyl or esterified form. A “free fatty acid” refers to nonesterified fatty acids, which are typically derived from triacylglycerol by cleavage of ester bonds and calculated as oleic according to AOCS Ca 5a-40 (2017).

A “saturated” fatty acid is a fatty acid that does not contain any carbon-carbon double bonds in the hydrocarbon chain. An “unsaturated” fatty acid contains one or more carbon-carbon double bonds. A “polyunsaturated” fatty acid contains more than one such carbon-carbon double bond while a “monounsaturated” fatty acid contains only one carbon-carbon double bond. Carbon-carbon double bonds may be in one of two stereoconfigurations denoted cis and trans. Naturally occurring unsaturated fatty acids are generally in the “cis” form. Epoxidized renewable oil or fat may include one or more epoxide rings formed from cis or trans carbon-carbon double bonds.

Non-limiting examples of fatty acids include C8, C10, C12, C14, C16 (e.g., C16:0, C16:1), C18 (e.g., C18:0, C18:1, C18:2, C18:3, C18:4), C20 and C22 fatty acids. For example, the fatty acids can be caprylic (8:0), capric (10:0), lauric (12:0), myristic (14:0), palmitic (16:0), stearic (18:0), oleic (18:1), linoleic (18:2) and linolenic (18:3) acids.

As used herein, “total polar material” or “TPM” refers collectively to compounds formed from the chemical degradation of frying oils that are more polar than the triacylglycerols of the frying oil.

As used herein, “average composite age” refers to the calculated age of a frying oil within a defined time period (days) of continuous frying, where the frying oil may be a mixture of used frying oil and fresh frying oil. As used herein, “used frying oil” refers to frying oil that has undergone one or more frying cycles in the preparation of fried food items and typically includes a detectable amount of frying oil degradation products (e.g., FFA, TPM, polymerized gums, and the like). Conversely, “fresh frying oil” as used herein refers to a frying oil that has not undergone a frying cycle. Calculating the average composite age of the frying oil in the vat can be performed according to the following equation:

$$Dn = ( 1 - \frac{Wn}{vat capacity} ) * ( D ( n - 1 ) + 1 ) ( n \geq 1 )$$

wherein
Dn is the average composite age in days of used frying oil in vat after frying n days and topping-off with fresh frying oil;
Wn is the weight of fresh frying oil needed to top-off the used frying oil in the frying vat and reach the vat capacity;
vat capacity is the weight of frying oil required in the vat for frying; and
D(n−1) is the average age in days after frying n−1 days.

In a “continuous frying” process, fresh frying oil is used to top-off used frying oil within a frying vat of a frying apparatus, where used frying oil may be discharged as needed. The term “continuous” as used in the phrase “continuous frying” does not require that frying (i.e., process of preparing food by deep-frying at temperatures between 150-200° C.) itself occurs continuously, but “continuous frying” refers to the use of a combination of the used frying oil and top-off with fresh frying oil, and optionally discharging an amount of used frying oil, without requiring entirely changing out the frying oil in the frying vat as frequently as compared to conventional frying (i.e., batch frying) processes.

In one aspect, the present technology provides a continuous frying process for frying food, the process that includes:
maintaining two or more characteristics of a frying oil at a targeted value, wherein the targeted value of the two or more characteristics include: an average composite age of the frying oil in a range of about 2 days to about 12 days; and a measured total polar material (TPM) value of about 10% to less than or equal to about 22%; and
frying a food item in the frying oil at a daily food load of about 0.5 or greater.

In any aspect, the process occurs in a frying apparatus, and wherein the process does not require emptying, or substantially emptying, a frying vat of the frying apparatus.

In any aspect, the TPM value may be in a range from about 12% to about 20%. In any aspect, the TPM may be in a range from about 13% to about 17%. In any aspect, the TPM value may be in a range of about 16% to about 19%. For example, the TPM range may be about 10%, about 11%, about 12%, about 13%, about 14%, about 15%, about 16%, about 17%, about 18%, about 19%, about 20%, about 21%, about 22%, or any range including and/or in between any two of the preceding values.

In any aspect, the daily food load is in a range of about 0.5 or greater. As used herein, the “daily food load” refers to the calculated daily food-to-oil (or food-to-vat oil capacity) ratio of the weight amount of food prepared via frying to the vat capacity (by weight) of a fryer (e.g., if the vat capacity is 30 lbs, 30 lbs of frying oil maintains in vat or frying) on a given day of a continuous frying process. For example, the daily food load may be about 0.5, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, or any range including and/or in between any two of the preceding values. In any aspect, the daily food load may be in a range of about 0.7 to about 4.0. In any aspect, the daily food load may be in a range of about 0.5 to about 5.0.

In any aspect, the continuous frying process includes an average composite age of the frying oil that is about 2 days to about 12 days. For example, the average composite age of the frying oil may be about 2 days, about 3 days, about 4 days, about 5 days, about 6 days, about 7 days, about 8 days, about 9 days, about 10 days, about 11 days, about 12 days, or any range including and/or in between any two of the preceding values. In any aspect, the average composite age of the frying oil may be about 4 days to about 8 days. In any aspect, the average composite age of the frying oil may be about 2 days to about 10 days. In any aspect, the average composite age of the frying oil may be about 2 days to about 8 days. In any aspect, the average composite age of the frying oil may be about 4 days to about 10 days. In any aspect, the average composite age of the frying oil may be about 3 days to about 9 days.

The frying oil in the continuous frying process of the present technology may be a mixture of used frying oil and fresh frying oil.

In any aspect, maintaining the two or more characteristics of the frying oil may include an in-and-out process, where an amount of used frying oil is discharged and the remaining used frying oil is topped-off with an amount of fresh frying oil. For example, maintaining the two or more characteristics of the frying oil may include: discharging an amount of the used frying oil from a frying vat of the frying apparatus; topping-off the used frying oil in the frying vat of the frying apparatus with an amount of fresh frying oil; or combinations thereof; wherein discharging the used frying oil does not require emptying, or substantially emptying, entirely from the frying vat. Maintaining the two or more characteristics of the frying oil may include calculating the amount of fresh oil needed to top-off the used frying oil.

For example, maintaining the average composite age of the frying oil may include optionally discharging an amount of the used frying oil from a frying vat of the frying apparatus; topping-off the used frying oil in the frying vat of the frying apparatus with an amount of fresh frying oil; and calculating the average composite age of the frying oil after discharging the used frying oil and topping-off with fresh frying oil according to the following equation:

$$Dn = ( 1 - \frac{Wn}{vat capacity} ) * ( D ( n - 1 ) + 1 ) ( n \geq 1 )$$

wherein
Dn is the average composite age in days of used frying oil in the frying vat after frying n days and topping-off with fresh frying oil;
Wn is the weight of fresh frying oil needed to top-off the used frying oil in the frying vat and reach the vat capacity;
vat capacity is the weight of frying oil required in the vat for frying; and
D(n−1) is the average age in days after frying n−1 days.

In any aspect, the process may further include determining the amount of used frying oil to optionally discharge from the frying vat of the frying apparatus sufficient to maintain the two or more characteristics of the frying oil. Additionally or alternatively, in any aspect, the process may further include determining the amount of fresh frying oil for topping-off the used frying oil sufficient to maintain the two or more characteristics (i.e., average composite age and TPM) of the frying oil. For example, to determine a sufficient amount of used frying oil for discharging and/or fresh frying oil for topping-off, the amount may be calculated according to the following equation:

$$\frac{Tn ( Wn - Wo ) + T 0 Wt}{vat capacity} = Tt$$

Wn−Wo+Wt=vat capacity
   wherein:
Tn is TPM measured at n day(s);
Wn is the frying oil weight in the frying vat at n day(s);
Wo is the amount of used frying oil discharged (i.e., taken out) from the frying vat and fresh frying oil for topping-off to maintain the two or more characteristics of the frying oil;
vat capacity is the amount of frying oil required for continuous frying.
T0 is the TPM of fresh frying oil;
Wt is the amount of frying oil needed to be topped-off to maintain the frying oil level in the fryer vat capacity; and
Tt is the targeted TPM level.

In any aspect, the in-and-out process may be performed manually or automatically. In any aspect, the in-and-out process is a manual in-and-out process. As used herein, the term “manual” refers to an in-and-out process involving substantial input from or physical performance by an individual to execute one or more of the process steps. Systems and methods for automatically performing the in-and-out process as described herein are described in International Patent Application Publication No. WO 2020/139952, filed on Dec. 26, 2019, the entire contents of which are hereby incorporated by reference.

Generally, the frying oil may be any edible oil suitable for using in frying food for consumption. In any aspect, the frying oil may be a commodity frying oil. As used herein, “commodity frying oil” refers to edible oils having wide availability and use in food applications, which are generally less expensive and exhibit lower stability and shorter fry life compared to premium frying oils. Suitable commodity frying oils may include, but are not limited to, soybean oil, canola oil, sunflower oil, corn oil, rapeseed oil, cottonseed, or mixtures thereof. In certain aspects, the process may include maintaining a commodity frying oil at a TPM of at least about 12% and at most about 20%. For example, the TPM of the commodity frying oil may be maintained at about 12%, about 13%, about 14%, about 15%, about 16%, about 17%, about 18%, about 19%, about 20%, or any range including and/or in between any two of the preceding values. In an aspect, the commodity frying oil may be maintained at a TPM of about 13% to about 19%, preferably about 13% to about 18%, more preferably about 14% to about 19%, and most preferably about 16% to about 19%.

In any aspect, the frying oil may be a premium frying oil. As used herein, a premium frying oil refers to a frying oil that exhibits high stability and improved oil fry life compared to a commodity frying oil. Suitable premium frying oil may include, but is not limited to, high oleic canola oil (HOCAN), high oleic sunflower oil, peanut oil, mid-oleic sunflower oil, or mixtures thereof. In certain aspects, the process may include maintaining a premium frying oil at a TPM of at least about 10% and at most about 18%. For example, the TPM of the premium frying oil may be maintained at about 10%, about 11%, about 12%, about 13%, about 14%, about 15%, about 16%, about 17%, about 18%, or any range including and/or in between any two of the preceding values. In an aspect, the premium frying oil may be maintained at a TPM of about 13% to about 19%, preferably about 13% to about 18%, and more preferably about 13% to about 16%.

In addition to maintaining the average composite age and TPM of the frying oil as described in any aspect herein, the process may further include maintaining additional characteristics of the frying oil. For example, the two or more characteristics may further include a free fatty acid (FFA) value, a Gardner red color value, or combinations thereof.

In any aspect, the process may further include maintaining a FFA value of less than about 2.5 weight percent (wt %). For example, the process may further include maintaining a FFA value of about 0.01 wt %, about 0.05 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, or any range including and/or in between any two of the preceding values. In any aspect, the FFA value may be in a range of about less than about 2.5 wt % to about 0.01 wt %, about 2.2 wt % to about 0.2 wt %, about 2.0 wt % to about 0.5 wt %, about 2.0 wt % to about 1.0 wt %, about 2.0 wt % to about 1.4 wt %, or about 1.8 wt % to about 0.3 wt %.

In any aspect, the process may further include maintaining a Gardner red color value of less than about 12. For example, the process may further include a Gardner red color value of about 11.5, about 11, about 10.5, about 10.0, about 9.5, about 9.0, about 8.5, about 8.0, about 7.5, about 7.0, about 6.5, about 6.0, about 5.5, about 5.0, about 4.5, about 4.0, about 3.5, about 3.0, about 2.5, about 2.0, or any range including and/or in between any two of the preceding values. In any aspect, the Gardner red color value may be in a range of about 2 to about 12, about 4 to about 10, or about 6 to about 10.

In any aspect, the present inventors surprisingly discovered an advantage of the process of the present technology is substantially reducing formation of 4-hydroxy-nonenal (HNE), which is a toxic aldehyde formed during the decomposition of vegetable oils, compared to a conventional frying process (i.e., batch frying) and frying oils not having the at least two characteristics of the frying oil.

Another advantage of the present technology may include reducing the amount of polymer gum build up during use of the frying apparatus. Without being bound by any particular theory, it is believed that maintaining the two or more characteristics of the edible frying oil according to the present invention surprisingly lowers the amount of polymer build-up (e.g., on the surfaces of the frying apparatus). Such reduction in polymer build-up has the further benefit of reducing the fryer vat cleaning frequency, the use of cleaning agents, and the overall cleaning cost.

In any aspect, the process may further include subjecting the frying oil to passive filtration, active filtration, or combinations thereof. Filtration techniques include active filtration and passive filtration. Active filtration refers to the phase separation/emulsion breaking or adsorption treatment of used frying oils to remove oil-soluble impurities. Passive filtration refers to removal of particulates with an inert filter medium. In any aspect, the process does not include subjecting the frying oil to active filtration. Generally, active filtration materials and techniques are more costly than passive filtration. The inventors discovered an advantage of the process of the present technology is avoiding or reducing the need to use active filtration to maintain the quality of the frying oil. In any aspect, the process does not include active filtration of the frying oil.

The inventors discovered the process of the present technology improves frying oil consumption. Typically, oil consumption is represented as an overall food-to-oil ratio (FOR). As used herein, the term “overall food-to-oil ratio” or “overall FOR” refers to a measured ratio of the total weight amount of food fried to the total weight amount of frying oil used during a given period (e.g., at least about 30 days) of the continuous frying process. In any aspect, the process of the present technology improves frying oil consumption compared to a control frying oil used in a conventional frying process. For example, the process of the present technology improves premium frying oil consumption compared to a control frying oil used in a conventional frying process. In any aspect, the process of the present technology improves frying oil consumption represented as overall FOR compared to a control frying oil not having the targeted value of the two or more characteristics.

In any aspect, the process exhibits an overall FOR of about 5.0 to about 25.0. For example, in any aspect, the process may exhibit at least one or more of the following:
an overall FOR of at least about 5.0 to about 9.0 at a daily food load of about 0.5 to at most about 1.5;
an overall FOR of at least about 9.0 to about 15.0 at a daily food load of greater than about 1.5 to at most about 2.0; or
an overall FOR of at least about 15.0 to about 20.0 at a daily food load of greater than about 2.0, preferably from greater than about 2.0 to about 5.0;
wherein the frying oil is a commodity frying oil.

In another example, according to any aspect, the process may exhibit at least one or more of the following:
an overall FOR of at least about 8.0 to at most about 14.0 at a daily food load of about 0.5 to at most about 1.0;
an overall FOR of at least about 14.0 to about 25.0 at a daily food load of greater than about 1.0 to at most about 2.0;
an overall FOR of at least about 15.0 to about 25.0 at a daily food load of greater than about 2.0, preferably from greater than about 2.0 to about 5.0;
wherein the frying oil is a premium frying oil.

In any aspect, the overall FOR exhibited by the process as described herein may be determined over a period of at least about 30 days. For example, the FOR may be determined over a period of about 30 days, about 45 days, about 60 days, about 75 days, about 90 days, about 105 days, about 120 days, about 135 days, about 150 days, about 165 days, about 180 days, about 195 days, about 210 days, about 225 days, about 240 days, about 255 days, about 270 days, about 285 days, about 300 days, about 315 days, about 330 days, about 345 days, about 360 days, about 365 days, or any range including and/or in between any two of the preceding values. In any aspect, the FOR exhibited by the process as described herein may be determined over a period of at least about 30 days to about 90 days, preferably from at least about 30 days to about 365 days.

Food prepared according to the process of the present technology may exhibit improved sensory quality compared to food fried in a conventional frying process and in a frying oil not having the targeted value of the two or more characteristics. Improved sensory quality of the fried food prepared according to the process of the present technology may include, but are not limited to, the overall liking, taste, aroma, texture, appearance, flavor, aftertaste, or combinations thereof.

The present invention, thus generally described, will be understood more readily by reference to the following examples, which are provided by way of illustration and are not intended to be limiting of the present invention.

### EXAMPLES

Example 1: High oleic canola (HOCAN), soybean oil, and palm olein (collectively “frying oils”) were used to test the feasibility of the continuous frying process as described herein. 40.5 lbs of par-fried fries were fried at 350° F. (~176.7° C.) for 3 min in each 30-lb vat every day until the TPM of each frying oil reached 15%. Then 81 lbs of par-fried fries were fried per vat per day to maintain a TPM value of 15% through manually taking oil out from the vat and adding the fresh oil into the vat prior to frying every day until the 95th day. For the control, control frying oils having TPM at 15% and TPM at 25%, respectively, were used to batch fry 40.5 lbs of par-fried fries at 350° F. (~176.7° C.) for 3 min in each vat (30 lb vats for control TPM 15% and 50 lb vats for control TPM 25%) every day until TPM of frying oils reached 15% and 25%. Then the frying oils in vats were used for sensory evaluation in comparison with the exemplary continuous frying process. In the frying process, the frying oil in each vat was passively filtered every 5 days with filtration paper. Table 1 shows the fresh oil quality in the study.

TABLE 1
Fresh oil quality of soybean oil, HOCAN, and palm olein.

| | Soybean oil | HOCAN | Palm Olein |
|---|---|---|---|
| Color AOCS Red (5.25″) | 0.6 | 0.7 | 3.5 |
| Free Fatty Acids as oleic (%) | 0.03 | 0.03 | 0.05 |
| Peroxide Value (meq/kg) | 0.18 | 0.24 | 0.74 |
| OSI @ 110 °C (h) | 7.63 | 14.62 | 21.57 |

### Results

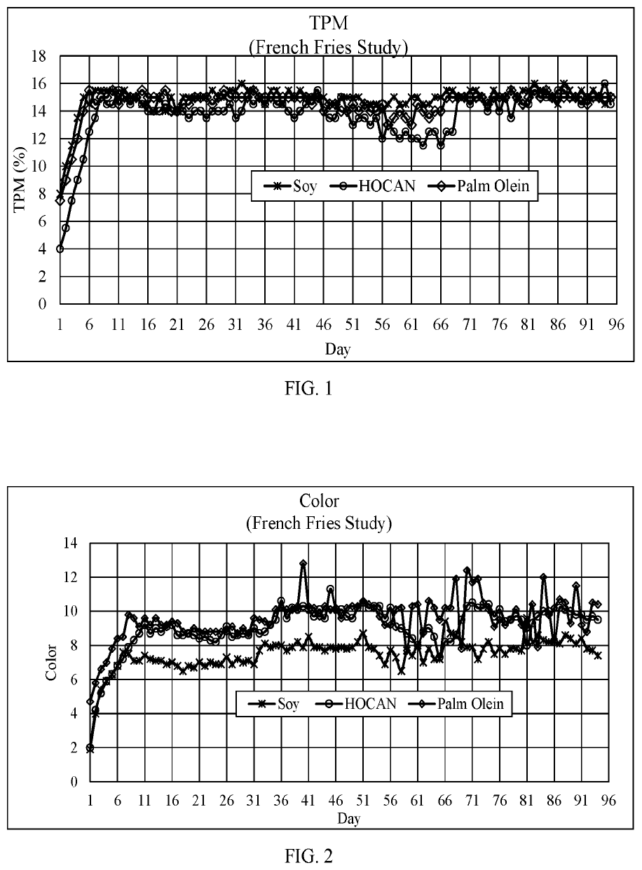

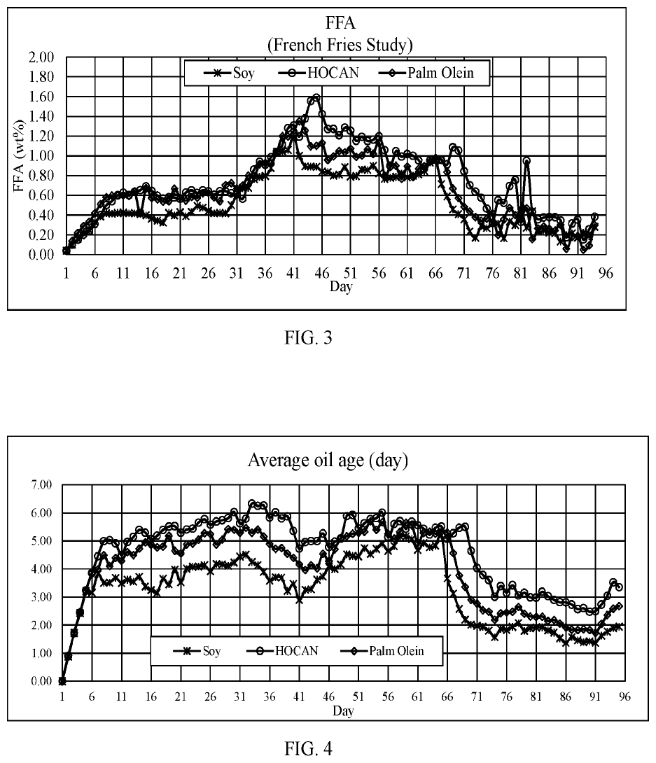

FIG. 1 shows the change of TPM (TPM measured by TESTO instrument) over time (Testo 270 Calibration and Adjustment Card). The frying oil used in the exemplary continuous frying process was able to maintain a TPM value at 15%. A slight decrease of TPM for HOCAN from Day 46 to Day 71 was observed due to the impact of par-fried fries with different lots, indicating the HOCAN vat can maintain TPM at 15% without manually taking extra frying oil out of the vat depending on daily fry load. FIGS. 2 and 3 show the Gardner red color values and FFA (measured according to AOCS Ca 5a-40 Method, revised 2017) content during the frying study, respectively. Gardner red color was measured using Lovibond Color apparatus with 10 mm color cell, and measurements were taken according to the following procedure:

### Procedure

A. Prepared sample and heated to 30 degrees with increased temperatures as needed to ensure sample was fully melted.
C. Selected desired color scale: 10 mm color cell.
E. Instrument was calibrated for zero.
G. Glass color cell was filled to at least 75% full with edible oil for measurement.
H. The color cell was placed into the Lovibond Color apparatus and color measurements were collected.

The color in the three exemplary frying oils was below 12. Generally, when the Gardner red color value of a frying oil exceeds 12, food items fried in the frying oil may have a dark color, particularly when frying French fries. The FFA of all frying oils was measured below 1.8%. As shown in FIG. 4, the average age of the frying oils was maintained in a range from about 4 to about 10 days throughout the continuous frying process.

Consumer sensory results showed that fries prepared according to the exemplary continuous frying process using soybean oil as the frying oil demonstrated an overall liking similar to fries fried in the control batch frying process with a TPM of 15%, but higher than control batch frying process with TPM of 25% in soybean oil at both day 30 and day 95 (Tables 2 and 3). In terms of color measurement, French fries fried in soybean oil via the exemplary continuous frying process showed a lightness color scale (i.e., Hunter L scale) similar to the control soybean oil in the batch frying process having a TPM of 15% but higher (i.e., lighter food color) than fries batch fried in the control soybean oil having a TPM of 25% at both day 30 and day 95. Using high stability oil (i.e., premium frying oil) such as HOCAN and palm olein oil as frying oils, good fried food flavor can be delivered even at TPM of 25% for consumers. Surprisingly, fries fried using the exemplary continuous frying process with HOCAN and palm olein exhibited an overall liking comparable to fries fried in the control batch frying process at a TPM of 15%. The color of fries fried in both HOCAN and palm olein in the exemplary continuous frying process is comparable to the color of fries fried in control batch frying process at TPM of 15% and lighter than control batch frying process at TPM of 25%. The present exampled demonstrated that fries fried in continuous frying process exhibits improved color compared to fries fried in control batch frying process at a TPM of 25%.

Consumer sensory evaluations were performed using a nine (9) point Hedonic scale:

| Score | Descriptor |
|---|---|
| 1 | Dislike Extremely |
| 2 | Dislike Very Much |
| 3 | Dislike Moderately |
| 4 | Slightly Dislike |
| 5 | Neither Like Nor Dislike |
| 6 | Like Slightly |
| 7 | Like Moderately |
| 8 | Like Very Much |
| 9 | Like Extremely |

TABLE 2
Consumer sensory results of fries fried in soybean oil at day 30

| | Soybean | Soybean | Soybean |
|---|---|---|---|
| | Oil | Oil Control | Oil Control |
| | Continuous | (Batch | (Batch |
| | Frying | Frying) | Frying) |
| | TPM 15% | TPM 15% | TPM 25% |
| | at Day 30 | at Day 30 | at Day 30 |
| Overall Liking | 7.4 a | 7.2 ab | 6.8 b |
| Overall Aroma | 7.4a | 7.1a | 6.6 b |
| Overall Appearance | 7.42a | 7.36ab | 7.05 b |
| Overall Flavor | 7.5 a | 7.1 ab | 6.8 b |
| Liking | | | |
| Overall Texture | 7.3 | 7.1 | 7.0 |
| Overall Aftertaste | 7.0 a | 7.0 a | 6.3 b |

*9-point hedonic scale (1 = “Dislike Extremely”; 9 = “Like Extremely”)
Means followed by different letters are significantly different from each other at p < 0.05
Means with different letters (A, B) indicated directional difference at 0.05 < p ≤ 0.10

TABLE 3
Consumer sensory results of fries fried in soy at day 95

| | | Soybean | Soybean |
|---|---|---|---|
| | Soybean | Oil | Oil |
| | Oil | Control | Control |
| | Continuous | (Batch | (Batch |
| | Frying | Frying) | Frying) |
| | TPM 15% | TPM 15% | TPM 25% |
| | at Day 95 | at Day 95 | at Day 95 |
| Overall Liking | 7.2A | 7.1A | 6.5B |
| Overall Aroma | 7.0ab | 7.1a | 6.6b |
| Overall Appearance | 7.0 | 7.1 | 6.8 |
| Overall Flavor | 7.2A | 7.0AB | 6.5B |
| Liking | | | |
| Overall Texture | 7.2 | 7.3 | 7.1 |
| Overall Aftertaste | 6.8ab | 6.9a | 6.0b |

*9-point hedonic scale (1 = “Dislike Extremely”; 9 = “Like Extremely”)
Means followed by different letters (a, b) are significantly different from each other at p < 0.05
Means with different letters (A, B) indicated directional difference at 0.05 < p ≤ 0.10

During the study, the oil consumption and overall food to oil ratio (FOR) were calculated and compared for the exemplary continuous frying process and conventional cycle based deep-frying (i.e., batch frying) process (Table 4). HOCAN demonstrated higher FOR than palm olein and soybean oil, indicating an inverse correlation between the amount HOCAN oil and total amount of fries fried in the process (i.e., food load). In other words, less HOCAN oil was needed to fry higher amounts of fries by using the exemplary continuous frying process. The exemplary continuous frying process exhibited a higher FOR than conventional frying process (control). Accordingly, more food can be fried with less oil.

TABLE 4
Frying oil consumption and FOR comparison at day
73 using exemplary continuous frying process.

| Exemplary Continuous | | Total amount | |
|---|---|---|---|
| Frying Process | Total amount of | of oil consumed | |
| maintaining | Fries fried (lbs) | (lbs) | Overall |
| TPM at 15% | (for 73 days) | (for 73 days) | FOR |
| Palm Olein | 5710.5 | 401.7 | 14.2 |
| Soy bean oil | 5751.0 | 473.9 | 12.1 |
| HOCAN | 5629.5 | 349.6 | 16.1 |
| Control frying process | Total amount | Total amount | |
| (Batch frying), discarding | of Fries fried | of oil consumed | Overall |
| frying oil at TPM of 25% | (lbs) | (lbs) | FOR |
| Palm Olein | 5402.0 | 470.7 | 11.5 |
| Soybean oil | 5655.9 | 492.6 | 11.5 |
| HOCAN | 5402.0 | 458.0 | 11.8 |

Example 2: In the study, soybean oil has been used to test the feasibility of the exemplary continuous frying process for protein product application. 30 lbs of commercially available par-fried Tempura Battered Chicken Nuggets (Commercial Sample 1) were fried at 350° F. (~176.7° C.) for 4 min in each 30-lb vat every day until the TPM of frying oils reached 15% for the exemplary continuous frying process. For the control batch frying process, 30 lbs of par-fried Tempura Battered Chicken Nuggets were fried at 350° F. for 4 min in each 30-lb vat every day until the TPM of frying oils reached 15% and 25%, respectively. For the exemplary continuous frying process, 30 lbs of par-fried chicken nuggets were continued to fry every day until day 30. In each frying process, the frying oil in each vat was passively filtered every 5 days with the filtration paper. The same soybean oil used in Example 1 was used in this example, the oil quality is shown in Table 1.

### Results

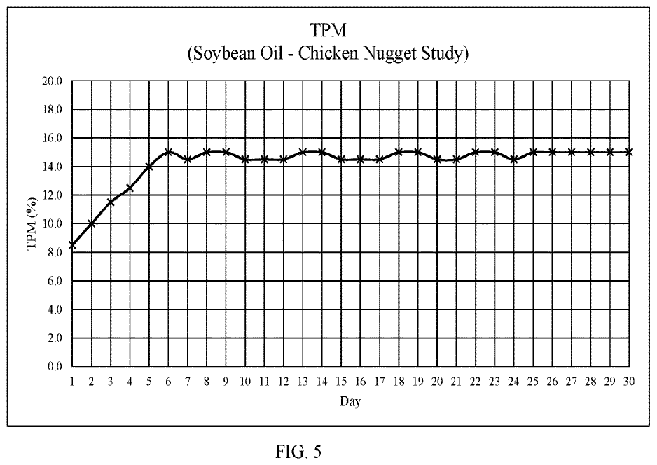

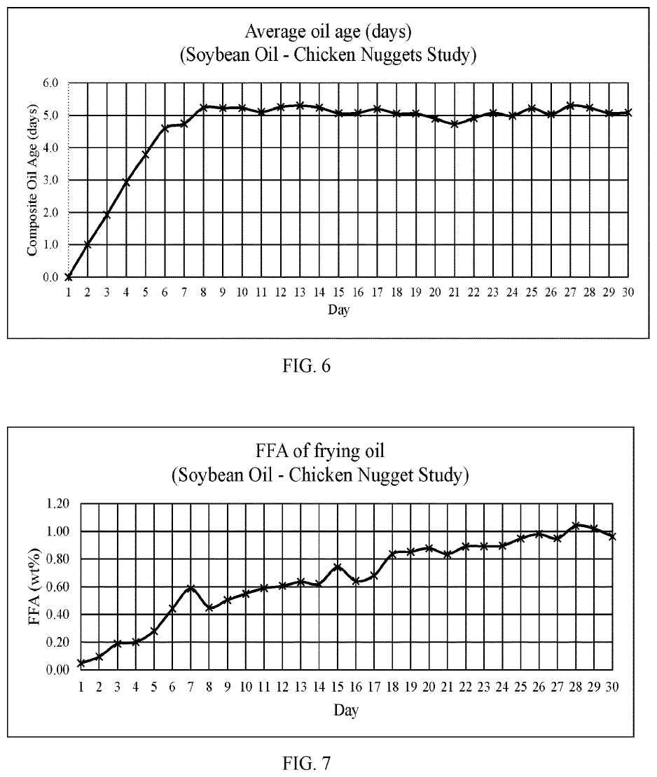

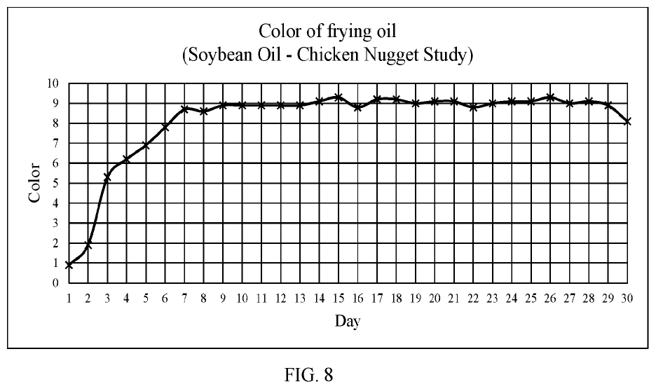

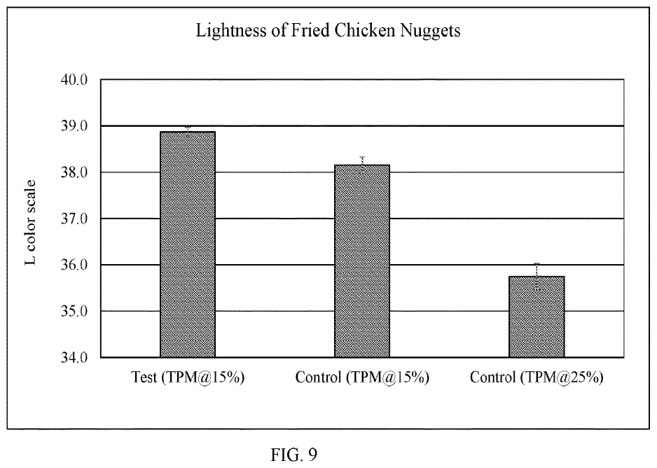

Similar to Example 1, the exemplary continuous frying process exhibited excellent results for preparing fried protein products. As shown in FIGS. 5 and 6, TPM was maintained at target of 15% through manually “in & out” process (i.e., adding fresh frying oil and/or removing used frying oil), along with an average oil age (days) of about 5.0 days. FIGS. 7 and 8 show the measured free fatty acid (FFA) content and Gardner red color value of frying oil (soybean oil) used in the study, indicating good quality of frying oil for high quality of fried food. Consumer sensory results showed that consumers have high tolerance to fried chicken products (Table 5). The nuggets fried on day 30 in the exemplary continuous frying process exhibited a lightness scale comparable to that in the control at TPM of 15%, and an improved Hunter L value that showed lighter color than nuggets fried in the control frying process at TPM 25% (FIG. 9). Accordingly, the exemplary continuous frying process exhibited more favorable fried food color compared to conventional (batch frying) process, especially when the frying oil is aged and its TPM is close to international limits recommended for discarding.

TABLE 5
Consumer sensory results of fries fried in soybean oil at day 30.

| | | Soybean | Soybean |
|---|---|---|---|
| | | Oil | Oil |
| | Soybean | Control | Control |
| | Oil | (Batch | (Batch |
| | Continuous | Frying) | Frying) |
| | Frying TPM | TPM 15% | TPM 25% |
| | 15% at Day 30 | at Day 30 | at Day 30 |
| Overall Liking | 7.3 | 6.9 | 7.3 |
| Overall Aroma | 7.3a | 6.7b | 7.4a |
| Overall | 7.5 | 7.6 | 7.6 |
| Appearance | | | |
| Overall Flavor | 7.4A | 6.9B | 7.1AB |
| Liking | | | |
| Overall Texture | 7.3 | 7.4 | 7.3 |
| Overall Aftertaste | 6.8 | 6.5 | 6.5 |

*9-point hedonic scale (1 = “Dislike Extremely”; 9 = “Like Extremely”)
Means followed by different letters (a, b) are significantly different from each other at p < 0.05
Means with different letters (A, B) indicated directional difference at 0.05 < p ≤ 0.10

Example 3: To further evaluate the impact of daily food load and target TPM on the overall food to oil ratio, an additional study using the exemplary continuous frying process was conducted. In the study, soybean oil, HOCAN, and palm olein were used as frying oils. 27 lbs of par-fried French fries were fried at 350° F. (~176.7° C.) for 3 min per day per vat (30 lb vat) until the TPM reached 15%. Subsequently, three different daily loads (27 lbs per vat, 54 lbs per vat, and 108 lbs per vat) of par-fried French fries were fried using the same frying condition per vat for a total 30 days. Each load of fries was fried for 10 days. Similar to Example 2, a different daily load with 90 lbs of chicken nuggets and a different TPM target at 18% were tested to understand the impact of daily load and TPM target on overall food to oil in frying. 90 lbs of chicken nuggets were fried per day for 10 days by maintaining TPM at 15% and 30 lbs of chicken nuggets were fried per day for 10 days by maintaining TPM at 18%. Yearly FOR values were calculated based on 30 day frying trial data for French fries and 10 day frying trial data for chicken nuggets, respectively.

### Results

No matter which load was used in the fry study, TPM of the frying oil in the vat was maintained at 15%, respectively, throughout the exemplary continuous frying process. With different loads, the color and free fatty acid content of frying oils were within international recommended limits.

### French Fries

Table 6 below provides calculated values for TPM target from 15% to 18%, which showed a higher overall FOR (calculated over yearly (365 day) period) and demonstrates significant impact for low and medium daily fry load. The amount of yearly frying oil consumed was calculated according to the following equation:

W=Wt+Wa*(365−n)

wherein,
W is the amount of yearly frying oil consumed in the continuous frying process;
Wt is the amount of oil used for frying from day 1 to day n when TPM of the frying oil reaches target;
Wa is the average daily top-off amount to maintain TPM target.

Yearly FOR is calculated by the equation below:

$$Y = \frac{L 1 * n + L 2 * ( 365 - n )}{W}$$

wherein:
Y is the yearly FOR;
L1 is the daily food load used for frying to reach the TPM target within n days;
L2 is the daily food load used in the study to maintain the TPM target;
n is the day when the TPM of the frying oil reaches the set target.

TABLE 6
Yearly Oil Consumed

| | Soybean | | Palm Olein | | HOCAN | |
|---|---|---|---|---|---|---|
| | The amount | The amount | The amount | The amount | The amount | The amount |
| | of yearly | of yearly | of yearly | of yearly | of yearly | of yearly |
| | oil | oil | oil | oil | oil | oil |
| Daily | consumed | consumed | consumed | consumed | consumed | consumed |
| Food | (lbs) for | (lbs) for | (lbs) for | (lbs) for | (lbs) for | (lbs) for |
| Load | TPM 15% | TPM 18%* | TPM 15% | TPM 18%* | TPM 15% | TPM 18%* |
| 0.9 | 1985.01 | 1231.31 | 1215.12 | 929.16 | 962.52 | 798.84 |
| 1.8 | 2284.21 | 1231.31 | 1387.99 | 1026.59 | 1111.66 | 1010.65 |
| 3.6 | 2232.01 | 2273.86 | 1920.39 | 2006.52 | 1792.07 | 1969.32 |

TABLE 7
Yearly FOR (French Fries)

| Daily | Soybean | | Palm Olein | | HOCAN | |
|---|---|---|---|---|---|---|
| Food | Yearly FOR | Yearly FOR | Yearly FOR | Yearly FOR | Yearly FOR | Yearly FOR |
| Load | TPM 15% | TPM 18% | TPM 15% | TPM 18% | TPM 15% | TPM 18% |
| 0.9 | 4.96 | 8.00 | 8.11 | 10.61 | 10.24 | 12.34 |
| 1.8 | 8.57 | 15.83 | 14.03 | 18.88 | 17.44 | 19.07 |
| 3.6 | 17.48 | 17.05 | 20.15 | 19.16 | 21.45 | 19.36 |

The calculated results showed that increasing the TPM and food load in the exemplary continuous frying process improved the overall FOR of soybean oil. Surprisingly, palm olein and HOCAN at higher food loads exhibited significantly higher overall FOR and high frying efficiency (Table 7).

### Chicken Nuggets

In the chicken nuggets frying study, Table 8 shows the impact of daily fry load and TPM target on overall FORs that were calculated for soybean oil.

TABLE 8
Yearly FORs at different TPM targets and daily fry loads

| | | | Amount of |
|---|---|---|---|
| | Daily | | Yearly Frying |
| TPM | Fry Load | Yearly | Oil consumed |
| (%) | (lb/vat/day) | FOR | (lbs) |
| 15 | 30 | 6.16 | 1778.85 |
| 15 | 90 | 19.47 | 1278.06 |
| 18 | 30 | 8.57 | 1668.53 |

The amount of yearly frying oil consumed was calculated according to the previously described.

As shown in Table 8, increasing daily food load from 30 lbs/vat/day to 90 lbs/vat/day showed significant improvement in calculated yearly (overall) FOR at TPM of 15%. Increasing the TPM target from 15% to 18% increased the calculated overall FOR by 40% for soybean oil.

### HNE Level Evaluation

In the studies, HINE amounts in the frying oil and fried food were evaluated, as shown in Tables 9 and 10. HNE was measured via liquid chromatography-mass spectrometry (LC-MS) according to the method reported by Wang et al. (J. Agric. Food Chem., 2016, 64, 3881-3889). The results indicated that HNE levels in both frying oils and fried food items from the exemplary continuous frying process are comparable to those in control batch frying process having a TPM at 15% and lower than those in the control batch frying process having a TPM at 25%.

TABLE 9
HNE level in frying oil and fried fries at
Day 75 in test process and control process.

| | HNE level in Test | HNE level in | HNE level in |
|---|---|---|---|
| | Process (μg/g) - | Control - TPM @ | Control - TPM @ |
| | TPM @ 15% | 15% (μg/g) | 25% (μg/g) |
| 350 °F/oil | | | |
| Palm Olein | 1.89 ± 0.06 | 2.97 ± 0.16 | 4.8 ± 0.24 |
| HOCAN | 2.59 ± 0.11 | 3.14 ± 0.12 | 7.98 ± 0.53 |
| Soybean oil | 3.43 ± 0.14 | 4.20 ± 0.13 | 9.54 ± 0.60 |
| 350 °F/Fries | | | |
| Palm Olein | 0.85 ± 0.14 | 1.18 ± 0.15 | 1.7 ± 0.269 |
| HOCAN | 1.66 ± 0.26 | 1.41 ± 0.16 | 2.67 ± 0.28 |
| Soybean oil | 1.97 ± 0.14 | 2.20 ± 0.15 | 3.28 ± 0.26 |

TABLE 10
HNE level on Day 30 in frying oil and fried chicken nuggets in
test exemplary continuous frying process and control tests.

| | HNE level in | HNE level in | HNE level in |
|---|---|---|---|
| | Test Process | Control - TPM | Control - TPM |
| | (μg/g) | @ 15% (μg/g) | @ 25% (μg/g) |
| HNE (μg/g) in oils | 5.49 ± 0.57 | 8.41 ± 0.49 | 9.63 ± 0.27 |
| HNE (μg/100 g) in | 3.14 ± 0.53 | 2.39 ± 0.13 | 4.13 ± 0.31 |
| chicken nuggets | | | |

### Exemplar Aspects

The following exemplary aspects are provided, the numbering of which is not to be construed as designating levels of importance:

Para. A: A continuous frying process for frying food, the process comprising:
maintaining two or more characteristics of a frying oil at a targeted value, wherein the targeted value of the two or more characteristics comprises:
   an average composite age of the frying oil in a range of about 2 days to about 12 days; and
   a measured total polar material (TPM) value of about 10% to less than or equal to about 22%; and
frying food in the frying oil at a daily food load of about 0.5 or greater.

Para. B: The process of Para. A, wherein the TPM value is in a range from about 12% to about 20%.

Para. C: The process of Para. A or Para. B, wherein the TPM value is in a range from about 13% to about 17%.

Para. D: The process of any one of Paras. A-C, wherein the TPM value is in a range of about 16% to about 19%.

Para. E: The process of any one of Paras. A-D, wherein the daily food load is in a range of about 0.5 to about 8.0.

Para. F: The process of any one of Paras. A-E, wherein the daily food load is in a range of about 0.7 to about 4.0.

Para. G: The process of any one of Paras. A-F, wherein the average age of the frying oil is about 2 days to about 10 days.

Para. H: The process of any one of Paras. A-G, wherein the frying oil is a commodity frying oil.

Para. I: The process of Para. H, wherein the commodity frying oil is selected from soybean oil, canola oil, sunflower oil, rapeseed oil, corn oil, cottonseed oil, or mixtures thereof.

Para. J: The process of any one of Paras. A-G, wherein the frying oil is a premium frying oil.

The process of Para. J, wherein the premium frying oil is selected from palm olein, high oleic canola oil (HOCAN), high oleic sunflower oil, peanut oil, mid-oleic sunflower oil, or mixtures thereof.

Para. K: The process of any one of Paras. A-J, wherein the frying oil comprises a mixture of used frying oil and fresh frying oil.

Para. L: The process of Para. K, wherein maintaining the two or more characteristics of the frying oil comprises:
discharging an amount of the used frying oil from the frying vat of the frying apparatus;
topping-off the used frying oil in the frying vat of the frying apparatus with an amount of fresh frying oil; or
combinations thereof;
wherein discharging the used frying oil does not require removing all, or substantially all, of the used frying oil.

Para. M: The process of Para. L further comprising determining the amount of used frying oil to discharge from the frying vat of the frying apparatus sufficient to maintain the two or more characteristics of the frying oil.

Para. N: The process of Para. L or Para. M further comprising determining the amount of fresh frying oil for topping-off the used frying oil sufficient to maintain the two or more characteristics of the frying oil.

Para. O: The process of any one of Paras. A-N, wherein maintaining the average composite age of the frying oil comprises:
optionally discharging an amount of used frying oil from the frying vat of the frying apparatus,
topping-off used frying oil in the frying vat of the frying apparatus with an amount of fresh frying oil; and
calculating the average composite age of the frying oil after discharging used frying and topping-off with fresh frying oil according to an equation:

$$Dn = ( 1 - \frac{Wn}{vat capacity} ) * ( D ( n - 1 ) + 1 ) ( n \geq 1 ) ;$$

wherein:
   Dn is the average composite age in days of used frying oil in vat after frying n days and topping-off with fresh frying oil;
   Wn is the weight of fresh frying oil needed to top-off the used frying oil in the frying vat and reach the vat capacity;
   vat capacity is the weight of frying oil required in the frying vat for frying; and
   D(n−1) is the average age in days after frying n−1 days.

Para. P: The process of any one of Paras. A-O, wherein the targeted value of the two or more characteristics further comprises:
a free fatty acid (FFA) value of less than about 2.5 weight percent (wt %);
a Gardner red color value of less than 12.

Para. Q: The process of Para. P, wherein the FFA value is about 0.2 wt % to about 2.2 wt %.

Para. R: The process of Para. P or Para. Q, wherein the FFA value is about 0.5 wt % to about 2.0 wt %.

Para. S: The process of any one of Paras. P-R, wherein the FFA value is about 1.0 wt % to about 2.0 wt %.

Para. T: The process of any one of Paras. P-S, wherein the FFA value is about 1.4 wt % to about 2.0 wt %.

Para. U: The process of any one of Paras. P-T, wherein the Gardner red value is about 2 to about 12.

Para. V: The process of any one of Paras. P-U, wherein the Gardner red value is about 4 to about 10.

Para. W: The process of any one of Paras. P-V, wherein the Gardner red value is about 6 to about 10.

Para. X: The process of any one of Paras. A-W further comprising subjecting the frying oil to filtration.

Para. Y: The process of any one of Paras. A-X, wherein the process improves frying oil consumption compared to a control frying oil used in a conventional frying process.

Para. Z: The process of any one of Paras. A-Y, wherein the process improves frying oil consumption compared to a control frying oil not having the targeted value of the two or more characteristics.

Para. AA: The process of any one of Paras. A-Z, wherein the process exhibits an overall food-to-oil ratio (FOR) of about 5.0 to about 25.0.

Para. AB: The process of any one of Paras. A-AA, wherein the process exhibits at least one of:
an overall FOR of at least about 5.0 to about 9.0 at a daily food load of about 0.5 to at most 1.5;
an overall FOR of at least about 9.0 to about 15.0 at a daily food load of greater than 1.5 to at most 2.0;
an overall FOR of at least about 15.0 to about 20.0 at a daily food load of greater than about 2.0;
wherein the frying oil is a commodity oil.

Para. AC: The process of any one of Paras. A-AB, wherein the process exhibits at least one of:
an overall FOR of at least about 8.0 to at most about 14.0 at a daily food load of about 0.5 to at most 1.0;
an overall FOR of at least about 14.0 to about 25.0 at a daily food load of greater than 1.0 to at most 2.0;
an overall FOR of at least about 15.0 to about 25.0 at a daily food load of greater than about 2.0;
wherein the frying oil is a premium frying oil.

Para. AD: The process of any one of Paras. AA-AC, wherein the FOR is determined over a period of at least about 30 days.

Para. AE: The process of any one of Paras. AA-AD, wherein the FOR is determined over a period of at least about 30 days to about 90 days.

Para. AF: The process of any one of Paras. AA-AE, wherein the FOR is determined over a period of at least about 30 days to about 365 days.

Para. AG: The process of any one of Paras. A-AF, wherein food fried according to the process exhibits improved sensory quality compared to food fried in a conventional frying process and not having the targeted value of the two or more characteristics.

Para. AH: The process of Para. AG, wherein the frying oil is a commodity oil having TPM of at least about 12% and at most about 20%.

Para. AI: The process of any one of Paras A-AH, wherein the process occurs in a frying apparatus, and wherein the process does not require emptying, or substantially emptying, a frying vat of the frying apparatus.

Para. AJ: The process of any one of Paras. A-AI, wherein the process reduces the generation of 4-hydroxy-nonenal (HNE), or combinations thereof compared to food fried in a conventional frying process and not having the targeted value of the two or more characteristics.

Each of the non-limiting aspects above can stand on its own or can be combined in various permutations or combinations with one or more of the other aspects or other subject matter described in this document. While the invention has been illustrated and described in certain aspects, a person with ordinary skill in the art, after reading the foregoing specification can effect changes, substitutions of equivalents and other types of alterations to the present technology as set forth herein. Each aspect described above can also have included or incorporated therewith such variations or aspects as disclosed in regard to any or all of the other aspects.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only and is not intended to be limiting. Thus, it is intended that the specification be considered as exemplary only with the breadth, scope and spirit of the present technology indicated only by the appended claims, definitions therein and any equivalents thereof.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter form the genus, regardless of whether or not the excised material is specifically.

1. A continuous frying process for frying food, the process comprising:
maintaining two or more characteristics of a frying oil at a targeted value, wherein the targeted value of the two or more characteristics comprises:
an average composite age of the frying oil in a range of about 2 days to about 12 days; and
a measured total polar material (TPM) value of about 10% to less than or equal to about 22%; and
frying food in the frying oil at a daily food load of about 0.5 or greater.

2. The process of claim 1, wherein the TPM value is in a range from about 12% to about 20%

3. The process of claim 1, wherein the daily food load is in a range of about 0.5 to about 8.0.

4. The process of claim 1, wherein the average age of the frying oil is about 2 days to about 10 days.

5. The process of claim 1, wherein the frying oil is a commodity frying oil, preferably wherein the commodity frying oil is selected from soybean oil, canola oil, sunflower oil, rapeseed oil, corn oil, cottonseed oil, or mixtures thereof.

6. The process of claim 1, wherein the frying oil is a premium frying oil, preferably wherein the premium frying oil is selected from palm olein, high oleic canola oil (HOCAN), high oleic sunflower oil, peanut oil, mid-oleic sunflower oil, or mixtures thereof.

7. The process of claim 1, wherein the frying oil comprises a mixture of used frying oil and fresh frying oil.

8. The process of claim 7, wherein maintaining the two or more characteristics of the frying oil comprises:
discharging an amount of the used frying oil from the frying vat of the frying apparatus;
topping-off the used frying oil in the frying vat of the frying apparatus with an amount of fresh frying oil; or
combinations thereof;
wherein discharging the used frying oil does not require removing all, or substantially all, of the used frying oil.

9. The process of claim 8 further comprising determining the amount of used frying oil to discharge from the frying vat of the frying apparatus sufficient to maintain the two or more characteristics of the frying oil.

10. The process of claim 8 further comprising determining the amount of fresh frying oil for topping-off the used frying oil sufficient to maintain the two or more characteristics of the frying oil.

11. The process of claim 1, wherein maintaining the average composite age of the frying oil comprises:
optionally discharging an amount of used frying oil from the frying vat of the frying apparatus,
topping-off used frying oil in the frying vat of the frying apparatus with an amount of fresh frying oil; and
calculating the average composite age of the frying oil after discharging used frying and topping-off with fresh frying oil according to an equation:
$$Dn = ( 1 - \frac{Wn}{vat capacity} ) * ( D ( n - 1 ) + 1 ) ( n \geq 1 ) ;$$
wherein:
Dn is the average composite age in days of used frying oil in vat after frying n days and topping-off with fresh frying oil;
Wn is the weight of fresh frying oil needed to top-off the used frying oil in the frying vat and reach the vat capacity;
vat capacity is the weight of frying oil required in the frying vat for frying; and
D(n−1) is the average age in days after frying n−1 days.

12. The process of claim 1, wherein the targeted value of the two or more characteristics further comprises:
a free fatty acid (FFA) value of less than about 2.5 weight percent (wt %);
a Gardner red color value of less than 12.

13. The process of claim 1 further comprising subjecting the frying oil to filtration.

14. The process of claim 1, wherein the process improves premium frying oil consumption compared to a control frying oil used in a conventional frying process.

15. The process claim 1, wherein the process exhibits an overall food-to-oil ratio (FOR) of about 5.0 to about 25.0.

16. The process of claim 1, wherein food fried according to the process exhibits improved sensory quality compared to food fried in a conventional frying process and not having the targeted value of the two or more characteristics.

17. The process of claim 1, wherein the process occurs in a frying apparatus, and wherein the process does not require emptying, or substantially emptying, a frying vat of the frying apparatus.

18. The process of claim 1, wherein the process reduces the generation of 4-hydroxy-nonenal (HNE), or combinations thereof compared to food fried in a conventional frying process and not having the targeted value of the two or more characteristics.
